(19) United States
(12) Patent Application Publication
(10) Pub. No.: US 2003/0016951 A1
(43) Pub. Date: Jan. 23, 2003

(54) DVD bookmark apparatus and method

(75) Inventors: Donald Paul Jakel, Rochester, MN (US); Eric John Nelson, Rochester, MN (US); Steven Thomas Will, Rochester, MN (US)

Correspondence Address: Derek P. Martin, MARTIN & ASSOCIATES, L.L.C., P.O. Box 548, Carthage, MO, 64836-0548, US

(73) Assignee: International Business Machines Corporation, Armonk, NY

(21) Appl. No.: 09/908,256

(22) Filed: Jul. 18, 2001

(51) Int. Cl. H04N 5/76; H04N 5/781

(52) U.S. Cl. 386/125; 386/126

(57) ABSTRACT

An apparatus and method allow a user to define markers referred to herein as “bookmarks” that are used to mark portions of a DVD. One type of bookmark defined herein is a position bookmark that creates a mark that corresponds to a position on the DVD. Another type of bookmark is an interval bookmark that comprises two position bookmarks that define the beginning and end of an interval on the DVD. Yet another type of bookmark is an interval sequence that lists multiple intervals defined by interval bookmarks. An interval sequence may include intervals from a single DVD, or may include intervals from multiple DVDs as well. Once an interval sequence is defined, the information recorded on the DVD(s) that corresponds to the intervals in the sequence may be stored on a mass storage device, such as a hard disk drive. In this manner, several “clips” from different DVDs may be merged into a single video stream that may be displayed without breaks or interruptions.

### BACKGROUND OF THE INVENTION

1. Technical Field

This invention generally relates to the entertainment field, and more specifically relates to apparatus and methods for displaying a video signal.

2. Background Art

Digital video discs (DVDs) have become very popular in recent years due to the high quality of both video and audio signals that a DVD can store, as well as the durability of the DVD medium compared to magnetic media, such as VHS videotapes. Most DVDs divide their contents into predefined “chapters” stored on the DVD. Most known DVD players allow the user to select which chapter to display, thereby allowing somewhat random access to the chapter portions of a DVD. However, there is currently no way for a user to define a marker that the DVD player can recognize in the future to affect how the DVD is played. Without a way to allow a user to define markers that correspond to positions on the DVD, users will not have the freedom and flexibility to customize the presentation of the video signals stored on a DVD.

### DISCLOSURE OF INVENTION

According to the preferred embodiments, an apparatus and method allow a user to define markers referred to herein as “bookmarks” that are used to mark portions of a DVD. One type of bookmark defined herein is a position bookmark that creates a mark that corresponds to a position on the DVD. Another type of bookmark is an interval bookmark that comprises two position bookmarks that define the beginning and end of an interval on the DVD. Yet another type of bookmark is an interval sequence that lists multiple intervals defined by interval bookmarks. An interval sequence may include intervals from a single DVD, or may include intervals from multiple DVDs as well. Once an interval sequence is defined, the information recorded on the DVD(s) that corresponds to the intervals in the sequence may be stored on a mass storage device, such as a hard disk drive. In this manner, several “clips” from different DVDs may be merged into a single video stream that may be displayed without breaks or interruptions.

The foregoing and other features and advantages of the invention will be apparent from the following more particular description of preferred embodiments of the invention, as illustrated in the accompanying drawings.

### BRIEF DESCRIPTION OF DRAWINGS

The preferred exemplary embodiments of the present invention will hereinafter be described in conjunction with the appended drawings, where like designations denote like elements, and:

FIG. 1 is a block diagram showing a prior art DVD player;

FIG. 2 is a flow diagram of a prior art method for displaying information on a DVD;

FIG. 3 is a block diagram of a DVD player that allows a user to define one or more “bookmarks” that correspond to positions, intervals, or sequences of intervals on one or more DVDs in accordance with the preferred embodiments;

FIG. 4 is a block diagram showing in more detail the position bookmarks of FIG. 3;

FIG. 5 is a flow diagram showing the steps in a method for creating a position bookmark for a DVD in accordance with the preferred embodiments;

FIG. 6 is a block diagram showing in more detail the interval bookmarks of FIG. 3;

FIG. 7 is a flow diagram showing the steps in a method for creating an interval bookmark for a DVD in accordance with the preferred embodiments;

FIG. 8 is a block diagram showing in more detail the interval sequences of FIG. 3;

FIG. 9 is a flow diagram showing the steps in a method for creating an interval sequence from intervals on one or more DVDs in accordance with the preferred embodiments;

FIG. 10 is a block diagram that shows one example of an interval sequence that includes intervals from a single DVD;

FIG. 11 is a block diagram that shows another example of an interval sequence that includes intervals from multiple DVDs;

FIG. 12 is a block diagram that shows how the digital video portions of a DVD that correspond to interval sequence A in FIG. 10 may be stored in a mass storage, such as a hard disk drive, in accordance with the preferred embodiments;

FIG. 13 is a block diagram that shows how the digital video portions of DVDs that correspond to interval sequence B in FIG. 11 may be stored in a mass storage, such as a hard disk drive, in accordance with the preferred embodiments;

FIG. 14 is a block diagram showing functions that are included in the user interface for the apparatus of the preferred embodiments;

FIG. 15 is a display window showing a create tab in a bookmark functions menu that may be displayed to a user in accordance with the preferred embodiments;

FIG. 16 is a display window showing a display tab in the bookmark functions menu in accordance with the preferred embodiments;

FIG. 17 is a display window showing an edit tab in the bookmark functions menu in accordance with the preferred embodiments;

FIG. 18 is a display window showing an interval tab in the bookmark functions menu in accordance with the preferred embodiments; and

FIG. 19 is a display window showing a sequence tab in the bookmark functions menu in accordance with the preferred embodiments.

### BEST MODE FOR CARRYING OUT THE INVENTION

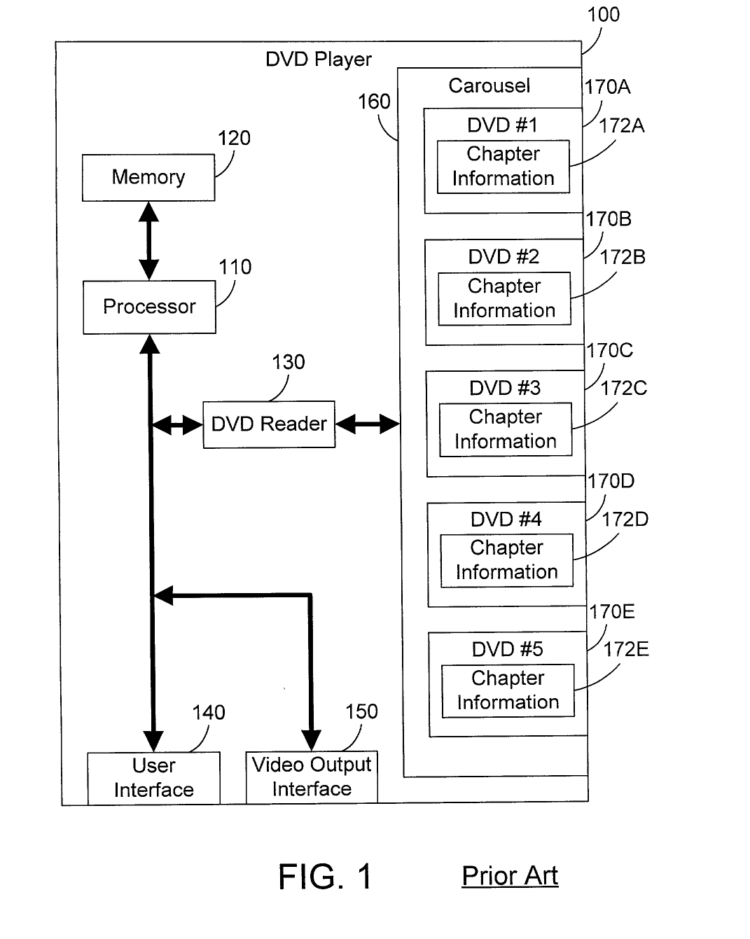

The advantages of the preferred embodiments are best understood against a backdrop of an understanding of the prior art. Referring to FIG. 1, a prior art DVD player 100 includes a processor 110 that is coupled to a memory 120, a DVD reader 130, a user interface 140, and a video output interface 150. Processor 110 is a microprocessor or microcontroller as is known in the art. Memory 120 is any type of memory known in the computer art, and is typically random access memory in known DVD players. DVD reader 130 is a mechanism that reads digital video information from a DVD. For this example, we assume that DVD player 100 includes a carousel 160 that can hold five DVDs, DVD #1 (170A), DVD #2 (170B), DVD #3 (170C), DVD #4 (170D), and DVD #5 (170E). In the prior art, it is known to divide the digital video information into a number of “chapters” so that a user may randomly access any defined chapter for viewing. The chapter information is recorded on each DVD, as shown by chapter information 172A, 172B, 172C, 172D, and 172E in FIG. 1. In the prior art as shown in FIG. 1, only one DVD may be playing at any given time. The user selects one of the five DVDs in the carousel 160 for viewing, and DVD reader 130 then reads the digital video information from the selected DVD.

User interface 140 is an interface that allows the user to control the function of the DVD player 100. User interface 140 includes buttons on the front of the DVD player as well as the combination of a hand-held wireless transmitter (i.e., remote control) that communicates with a receiver within the DVD player 100. Video output interface 150 is an interface that transforms the digital video information on a DVD to a video output signal that is output to a display device, such as a television.

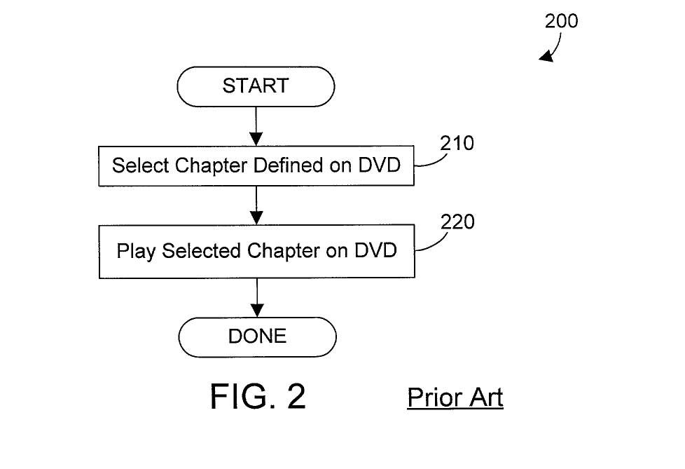

Referring to FIG. 2, a method 200 in accordance with the prior art shows how the chapter information 172 on a DVD 170 may be used. A user first selects a chapter defined on the DVD (step 210). The user can then play the selected chapter (step 220). In this manner, a user may use the user interface 140 of DVD player 100 to load any predefined chapter stored on a DVD for viewing. This feature provides random access to each chapter on the DVD. However, the chapters are predefined and recorded on the DVD, and cannot be defined or customized by the user. The user has no control over the definition of the chapters. If a user likes a car chase scene that spans the last half of a predefined chapter, the user must go to the beginning of the chapter and either view the first half of the chapter before coming to the car chase scene, or fast-forward through the first half of the chapter. In addition, there is currently no way for a user to combine digital video information from multiple DVDs into a common storage so that clips from multiple DVDs may be watched seamlessly.

An apparatus and method in accordance with the preferred embodiments allows a user to define different types of bookmarks that correspond to any DVD that is loaded in a DVD player of the preferred embodiments. A position bookmark corresponds to a particular position on the DVD. An interval bookmark corresponds to an interval on a DVD, such as an interval defined by two position bookmarks. An interval sequence corresponds to a sequence of intervals defined on a single DVD or on multiple DVDs. In addition, the digital video information corresponding to an interval sequence may be recorded in a mass storage coupled to the DVD so that an interval sequence that includes intervals from different DVDs may be watched seamlessly without the need of taking the time for the DVD player to load the different DVDs when the user wants to view the interval sequence. This capability also allows an interval sequence to be created that includes a number of DVDs that is greater than the number of DVDs the player may hold. By providing the capability of bookmarking DVDs and controlling the playback based on the bookmarks, the preferred embodiments greatly enhance the viewing flexibility of DVDs and hence the viewing pleasure of the user.

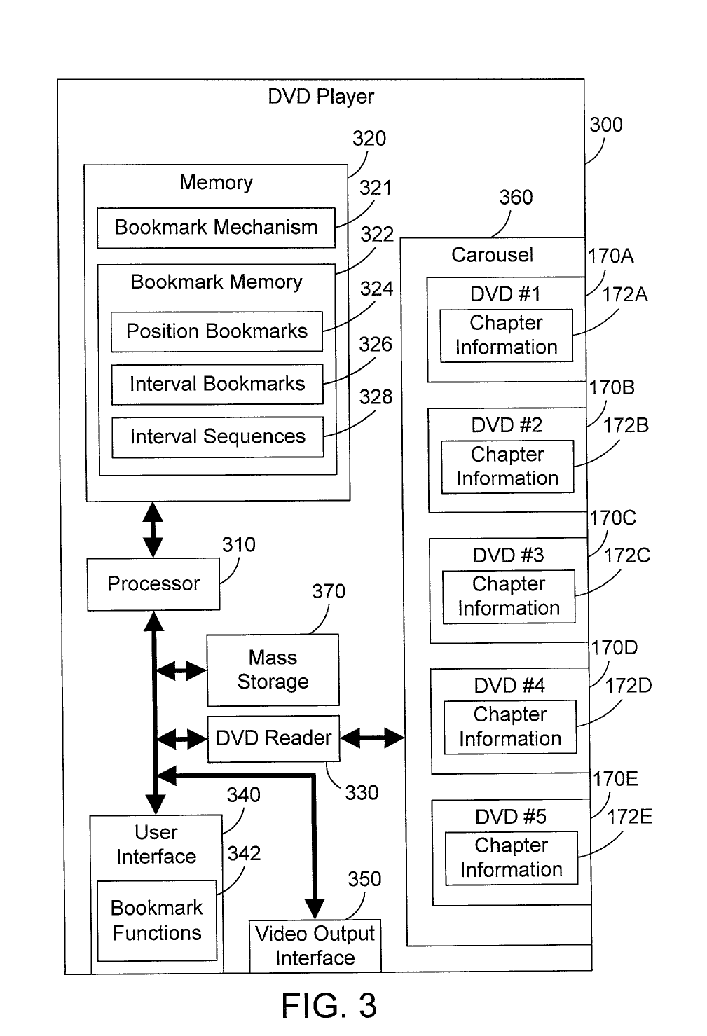

Referring now to FIG. 3, a DVD player 300 in accordance with the preferred embodiments includes a processor 310 coupled to a memory 320, a DVD reader 330, a user interface 340, a video output interface 350, and a mass storage 370. In the preferred embodiments, processor 310, DVD reader 330, video output interface 350, and carousel 360 are suitably the same as the corresponding components 110, 130, 150 and 160 in the prior art, described above with reference to FIG. 1. However, the preferred embodiments expressly extend to any additional function above and beyond that described with respect to the prior art in FIG. 1.

Memory 320 includes a bookmark mechanism 321 and bookmark memory 322. Bookmark memory 322 may include any suitably type of bookmark. In the preferred embodiments, three types of bookmarks are defined, namely: position bookmarks 324, interval bookmarks 326, and interval sequences 328. A position bookmark 324 defines a particular position on a corresponding DVD. A position bookmark may take any suitable form for defining a position on a DVD, including a time index, track number, etc. An interval bookmark 326 is defined by a beginning position on a DVD and an end position on the DVD. These two positions may be defined by position bookmarks 324. An interval sequence 328 is a sequence of two or more intervals such as those defined by interval bookmarks 326, and may include intervals from multiple DVDs.

User interface 340 includes bookmark functions 342 that are not known in the prior art that allow a user to use bookmark mechanism 321 to create one or more bookmarks in bookmark memory 322. Once bookmarks are defined in bookmark memory 322, the user may select via the bookmark functions 342 in the user interface 340 to view a DVD at a particular position bookmark 324, to view an interval on a DVD defined by an interval bookmark 326, or to view a sequence of intervals from one or multiple DVDs defined by an interval sequence 328. The combination of bookmark functions 342 in user interface 340, bookmark mechanism 321, and the stored bookmarks in bookmark memory 322 provide the user with incredible flexibility and control over the viewing of DVDs using the DVD player 300 of the preferred embodiments.

DVD player 300 includes a mass storage 370 that may be used to store the digital video information from portions of one or more DVDs. The preferred mass storage is a hard disk drive, but any suitable storage can be used. In the preferred embodiments, bookmark mechanism 321 includes the capability of defining an interval sequence 328 from multiple DVDs. The mass storage 370 allows the digital video information from each selected interval to be stored so the intervals from multiple DVDs may be viewed seamlessly without interruption. If mass storage 370 were not present, a user could still define an interval sequence with intervals from up to five DVDs (assuming a five disc carousel as shown in FIG. 3), but each time an interval from a different DVD were needed, the carousel would have to load the next DVD before it could play the next interval. This delay would be an inconvenience to the user. Mass storage 370 removes this limitation by storing the digital video information corresponding to the intervals in an interval sequence, which allows for seamless viewing of intervals from different DVDs. In addition, mass storage 370 removes the limitation of the number of DVDs a carousel can hold. A user could define an interval sequence that includes intervals from fifty different DVDs, and the video information from each interval could be stored in mass storage 370. Once all of the desired intervals in a sequence are loaded into mass storage 370, all the intervals (or “clips”) in the sequence may be viewed without interruption.

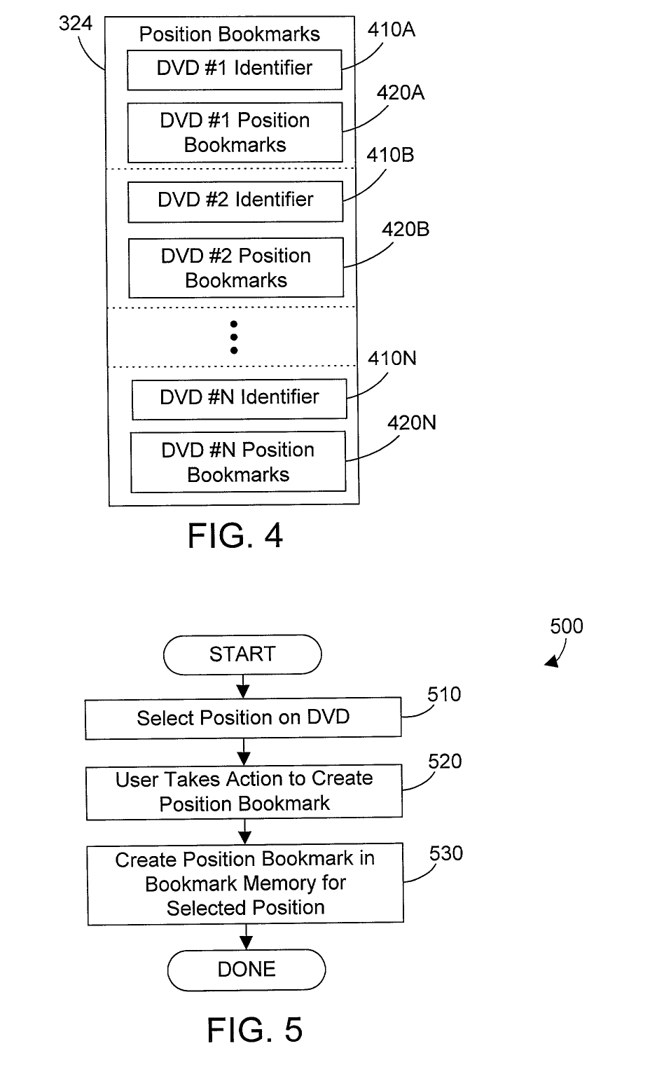

Referring to FIG. 4, the position bookmarks 324 in bookmark memory 322 include a DVD identifier 410 and bookmarks 420 that correspond to that particular DVD. Thus, as shown in FIG. 4, position bookmarks 420A for DVD #1 are correlated to the identifier 410A for DVD #1. In similar fashion, the identifiers 410 are shown in FIG. 4 as 410B through 410N, while the corresponding position bookmarks are shown as 420B through 420N. Note that the DVD identifier 410 could be different types of information. For example, DVD identifier 410 could be a unique serial number that is recorded on the DVD and that is unique from all other DVDs, including copies of the same movie or program. In the preferred embodiments, DVD identifier 410 is an identifier (such as the stored “title” on the DVD) that identifies the specific program but not the specific disc. This is preferred because a user could spend hours defining bookmarks for a DVD. If the user ever lost or damaged the DVD, the user could purchase a replacement and all the bookmarks would work with the new DVD. If the identifier 410 were unique to a particular copy of a DVD, the user would have to re-do all the bookmarks for the new copy of the DVD.

Referring to FIG. 5, a method 500 for defining a position bookmark in accordance with the preferred embodiments begins by selecting a position on a DVD (step 510). A user then takes action to create the position bookmark (step 520). Finally, the position bookmark is created in the DVD player's bookmark memory for the selected position (step 530).

Step 510 of selecting a position on a DVD may be performed in any suitable way. For example, a user could set a time index that defines a position bookmark. The preferred embodiments includes an “add bookmark” function in the user interface that allows a user to create a position bookmark as the user is watching a DVD, either as the DVD is playing or when the DVD is paused. Assuming an “add bookmark” button is available on the wireless remote control, the user can simply click on the “add bookmark” button when the user desires to add a bookmark for the DVD being played.

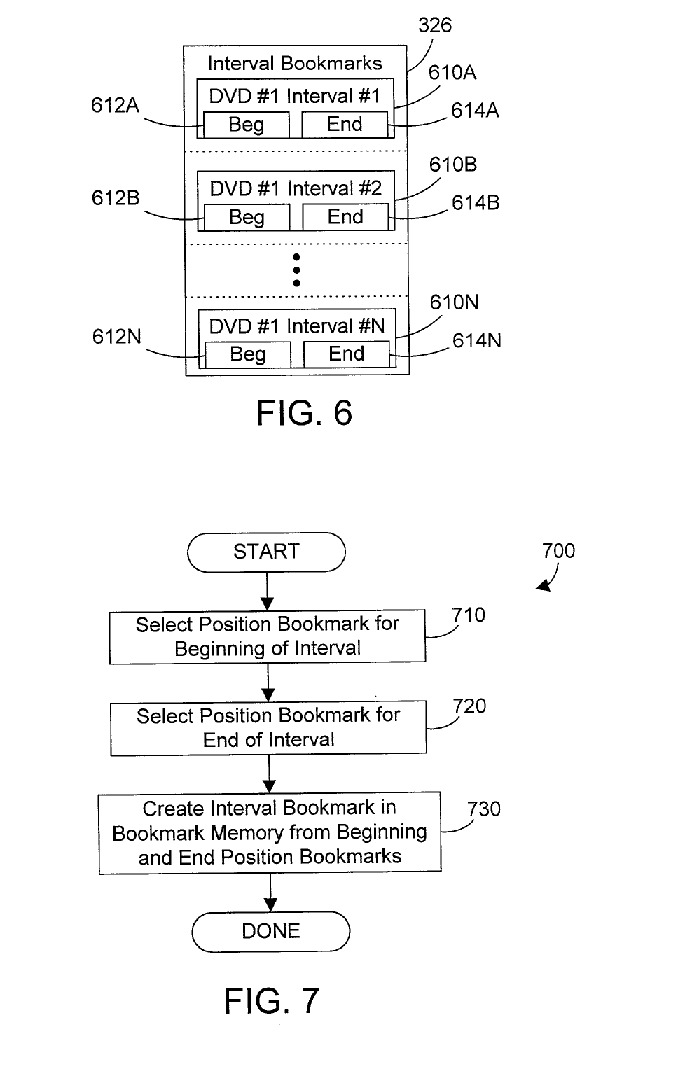

Referring now to FIG. 6, interval bookmarks 326 include intervals 610 for a DVD that are defined by a beginning position 612 and an end position 614. Thus, in FIG. 6, DVD #1 interval #1 610A includes a beginning position 612A and an end position 614A. In similar fashion, DVD #1 interval #2 610B includes a corresponding beginning position 612B and end position 614B, and DVD #1 interval #N 610N includes a corresponding beginning position 612N and end position 614N. Note that interval bookmarks may include intervals from different DVDs.

FIG. 7 shows the steps in a method 700 for creating an interval bookmark in accordance with the preferred embodiments. First, a position bookmark is selected as the beginning of the interval (step 710). Next, a position bookmark is selected as the end of the interval (step 720). Finally, an interval bookmark is created from the beginning and end position bookmarks (step 730). It is also within the scope of the preferred embodiments to define the beginning and end of the interval explicitly rather than selecting predefined position bookmarks.

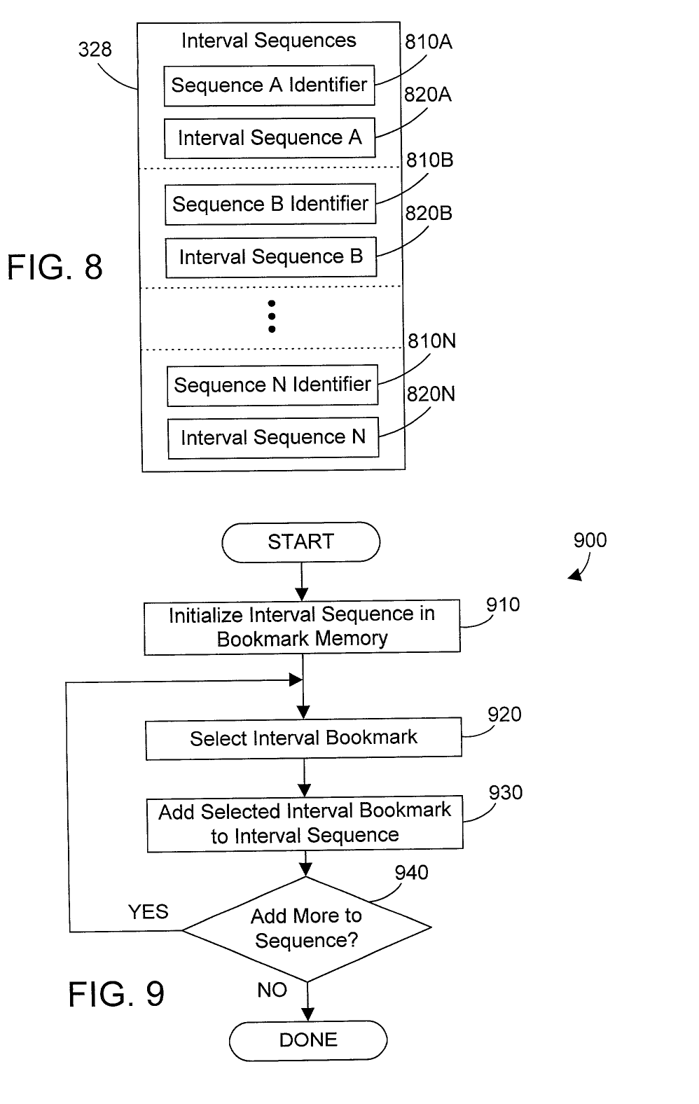

Referring to FIG. 8, interval sequences 328 include a sequence identifier 810 and a corresponding sequence of intervals 820. Thus, as shown in FIG. 8, sequence A has an identifier 810A that is correlated to its interval sequence 820A. Similarly, sequence B has an identifier 810B correlated to its interval sequence 820B, and sequence N has an identifier 810N correlated to its interval sequence 820N. Note that the sequence identifier is an identifier for the sequence, not for any particular DVD. This allows intervals from multiple DVDs to be stored in a single interval sequence.

A method 900 shown in FIG. 9 shows the steps for creating an interval sequence according to the preferred embodiments. First, the interval sequence is initialized in bookmark memory (step 910). This initialization includes the creation of the sequence identifier 810. A user then selects an interval bookmark (step 920), and takes appropriate action on the user interface to add the selected interval bookmark to the interval sequence (step 930). If the user wants to add more intervals to the sequence (step 940=YES), steps 920 and 930 are repeated until the user does not wish to add any more intervals to the sequence (step 940=NO). Note that the intervals selected in step 920 and added to the sequence in step 930 may be any defined interval on any DVD. Thus, an interval sequence may include intervals (or “clips”) from many different DVDs.

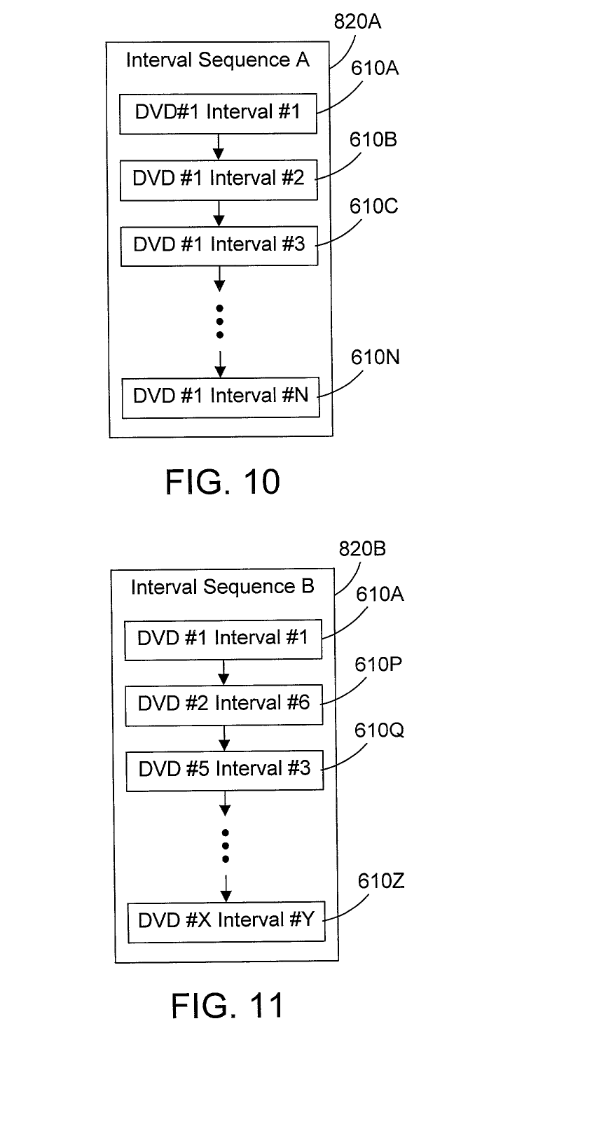

Referring to FIG. 10, an interval sequence A 820A is shown that includes intervals from a single DVD. We assume for this example that method 900 in FIG. 9 creates an interval sequence in the form of a linked list of intervals. Thus, step 930 in FIG. 9 adds intervals to a sequence by adding an interval to the bottom of the linked list. As shown in FIG. 10, any suitable number of intervals (e.g., 610A, 610B, 610C, . . . ,610N) from a single DVD can be combined into an interval sequence.

An interval sequence can also include intervals from multiple DVDs, as shown by interval sequence B 820B in FIG. 11. Interval sequence B 820B includes interval #1 from DVD #1 (610A), followed by interval #6 from DVD #2 (610P), followed by interval #3 from DVD #5 (610Q), followed by other intervals not listed, ending with interval #Y from DVD #X (610Z). Interval sequence 820 thus may include any suitable number of intervals from any suitable number of DVDs.

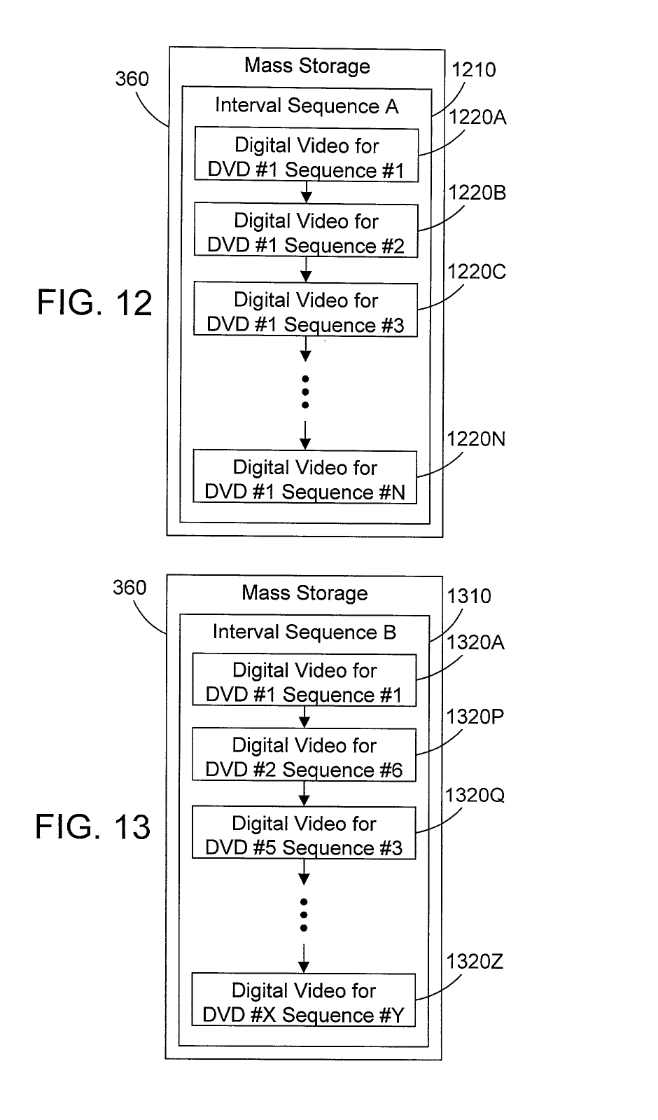

Referring to FIG. 3, mass storage 370 provides the capability of creating a user-defined sequence of digital video information from one or more DVDs that correspond to a defined interval sequence. For example, referring to FIG. 12, an interval sequence A 1210 is stored in mass storage 370 and corresponds to the interval sequence A 820A in FIG. 10. Note that the interval sequence A 1210 includes the actual digital video information for each defined interval in the sequence, rather than just defining the time borders for the sequence. In this manner a user may define an interval sequence, and may then take appropriate action to store the corresponding digital video in the mass storage 370. This allows the sequence of intervals to be watched seamlessly, without interruption or changing of discs.

Referring now to FIG. 13, an interval sequence B 1310 is shown residing in mass storage 370 that includes the digital video information for each interval defined in interval sequence B 820B of FIG. 11. Note how mass storage 370 allows the digital video information from different DVDs to be stored together in the same interval sequence, thereby allowing interval sequence B 1310 to be played without interruption. Interval sequences 1210 of FIG. 12 and 1310 in FIG. 13 represent digital video sequences that are stored in mass storage 370.

The ability to create user-defined sequences of digital video information is a powerful concept that can greatly enhance the user's viewing experience. For example, let's assume that a user really likes car chase scenes in movies. The user could bookmark intervals corresponding to car chase scenes in movies on several different DVDs, and could then create an interval sequence with many different car chase scenes from many different movies. The user could then store the digital video information for each interval on each DVD into mass storage, thereby allowing the user to view the sequence of “video clips” seamlessly, without interruption. If a user likes love scenes, the user can compile a custom sequence of love scene clips from different DVDs. In this manner the user can create bookmarks and sequences of corresponding digital video information that greatly enhance the viewing pleasure of the user.

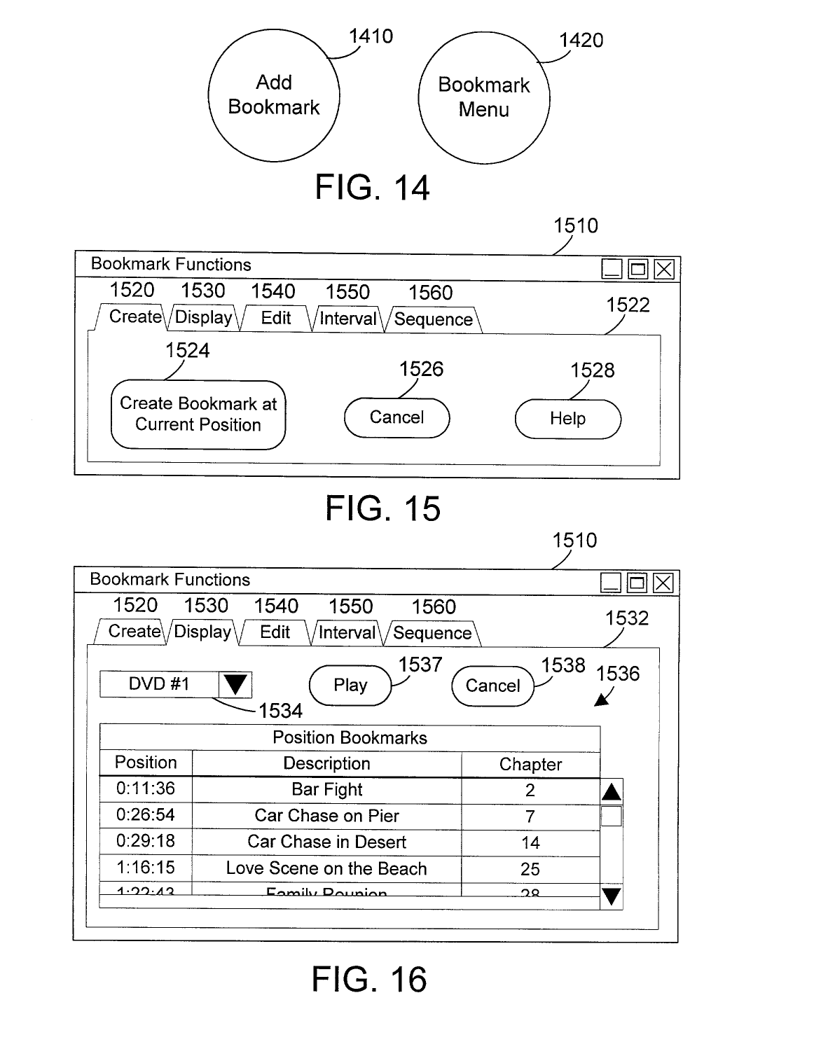

Referring to FIG. 14, two buttons are shown that may be included in user interface 340 in accordance with the preferred embodiments. An “add bookmark” button 1410 may be pressed to add a bookmark at the current position of the currently-loaded DVD. A “bookmark menu” button 1420 may be pressed to display a menu of different bookmark functions that are available to a user. These buttons 1410 may be included on the front panel of the DVD player 300, on a remote control for the DVD player 300, or both.

FIGS. 15-19 show specific examples of menus and displays in the bookmark functions portion 342 of user interface 340. Referring to FIG. 15, a bookmark functions display window 1510 shows five tabs that may be selected by a user: create 1520, display 1530, edit 1540, interval 1550, and sequence 1560. In FIG. 15, the create tab 1520 has been selected, so the display area 1522 displays functions that are available to create a bookmark. A “create bookmark at current position” 1524 creates a position bookmark at the current position of the DVD. A cancel button 1526 allows the user to get out of the bookmark functions menu 1510. A help button 1528 provides context-sensitive help for the user.

Referring to FIG. 16, display window 1510 shows that the display tab 1530 has been selected, so display area 1532 displays position bookmarks. A user may select a DVD that has stored position bookmarks from a drop-down list 1534. The position bookmarks for the selected DVD are then displayed in table 1536. For this specific example, the time-index position of the bookmark is shown, and a description of the bookmark as entered by the user is shown. Table 1536 may optionally include a column that correlates the position bookmark to the chapter information stored on the DVD. This would allow the user to view the chapter corresponding to the position bookmark in case other bookmarks need to be created as well. A user may select a position bookmark in table 1536, then click on the “play” button 1537 to begin playing the DVD at the position indicated by the selected bookmark. Clicking on the “cancel” button 1538 allows the user to get out of the bookmark functions menu 1510.

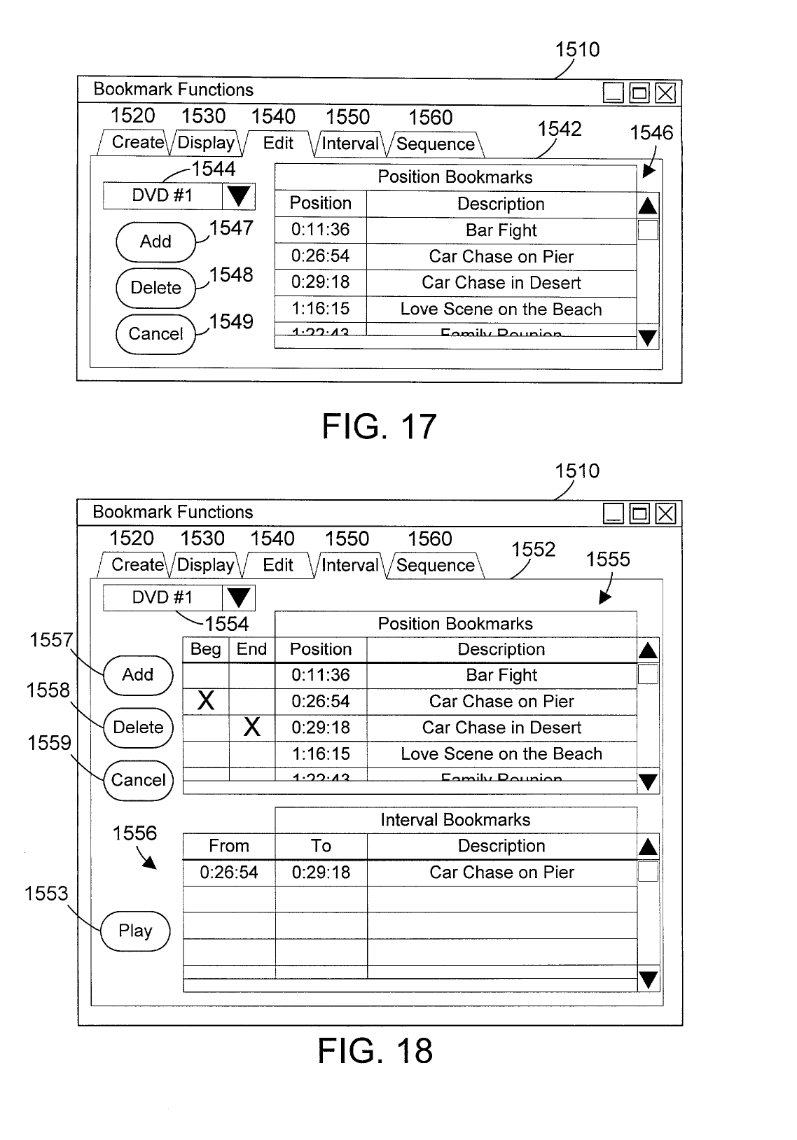

Referring to FIG. 17, display window 1510 shows that the edit tab 1540 has been selected, so display area 1542 displays functions that allow editing position bookmarks. A user may select a DVD that has stored position bookmarks from a drop-down list 1544. The position bookmarks for the selected DVD are then displayed in table 1546. For this specific example, the time-index position of the bookmark is shown in hours:minutes:seconds format, and a description of the bookmark as entered by the user is shown. An “add” button 1547 may be clicked to add the current DVD position as a position bookmark. One or more position bookmarks in table 1542 may be selected, and clicking on the “delete” button 1548 will delete the selected bookmarks. Clicking on the “cancel” button 1549 allows the user to get out of the bookmark functions menu 1510.

Referring to FIG. 18, display window 1510 shows that the interval tab 1550 has been selected, so display area 1552 displays functions that relate to interval bookmarks. A user may select a DVD that has stored position bookmarks from a drop-down list 1554. The position bookmarks for the selected DVD are then displayed in table 1555. Note that table 1555 include columns labeled “Beg” and “End”. A user may select any position bookmark as the beginning of an interval by clicking on the Beg column for that position bookmark, which marks the Beg column with an X to indicate that the bookmark has been selected as a beginning of an interval. Any position bookmark later in time than the beginning position bookmark may then be selected as the end of the interval by clicking on the End column for that bookmark, which marks the End column with an X to indicate that the bookmark has been selected as the end of an interval. For the specific example in FIG. 18, the “car chase on pier” position bookmark has been selected by the user as the beginning of an interval, and the “car chase in desert” bookmark has been selected by the user as the end of the interval. The user then clicks on the “add” button 1557 to add the defined interval to the list of interval bookmarks shown in table 1556. An interval has now been created in table 1556 that includes the interval from the beginning position bookmark (at time index 0:26:54) to the end position bookmark (at time index 0:29:18), that is named by the user “car chase on pier”. Other intervals may be defined in similar manner. Note that a position bookmark in table 1555 or an interval bookmark in table 1556 may be deleted by selecting the bookmark and clicking on the “delete” button 1558. In addition, an interval bookmark may be played by selecting an interval bookmark in table 1556, then clicking on the “play” button 1553. Clicking on the “cancel” button 1559 allows the user to get out of the bookmark functions menu 1510.

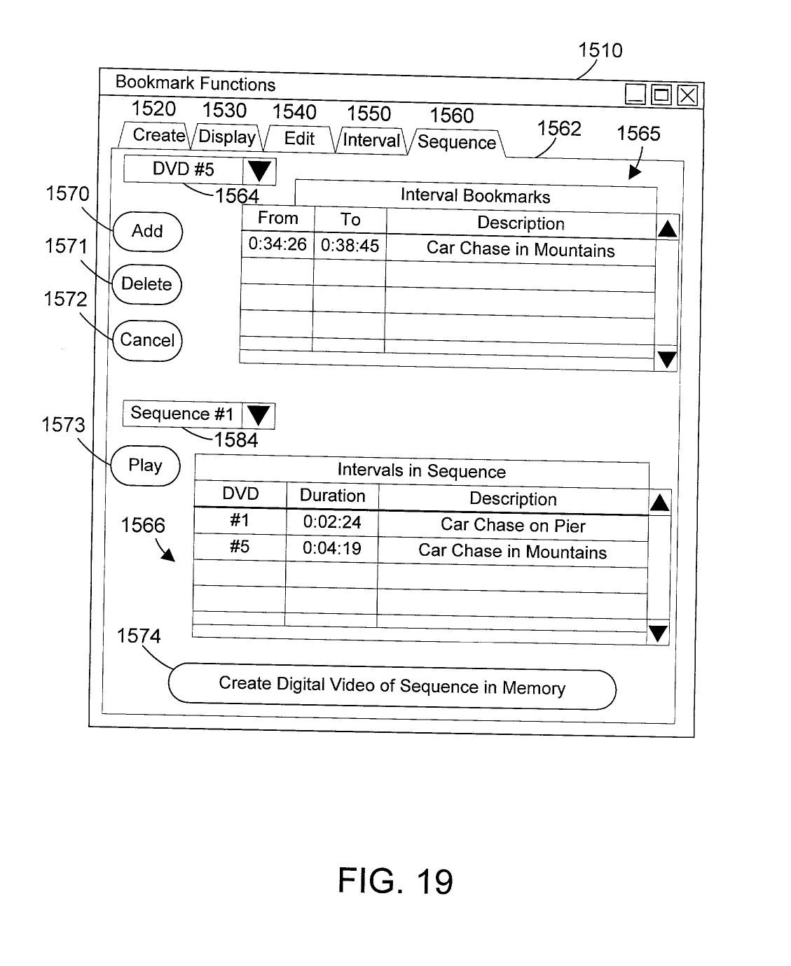

Referring to FIG. 19, display window 1510 shows that the sequence tab 1560 has been selected, so display area 1562 displays functions that relate to interval sequences. A user may select a DVD that has stored interval bookmarks from a drop-down list 1564. The interval bookmarks for the selected DVD are displayed in table 1565. A user may select any interval in table 1565, and by clicking on the “add” button 1570, the selected interval is added to the interval sequence shown in table 1566. For the specific example in FIG. 19, we assume that the “car chase on pier” interval bookmark was first added to the sequence in table 1566, and that the interval bookmarks for DVD #5 are now displayed in table 1565. We assume that the user selects the “car chase in mountains” interval from DVD #5 and clicks the “add” button 1570, which adds the car chase in mountains interval to the sequence, as shown in table 1566. Note that table 1566 includes a “DVD” column to indicate the DVD corresponding to the defined interval. An interval bookmark in table 1565 or an interval bookmark in the sequence in table 1566 may be deleted by selecting the interval bookmark and clicking on the “delete” button 1571. Deleting the interval bookmark in table 1565 preferably deletes the interval bookmark altogether, while deleting the interval bookmark in table 1566 only results in removing the interval bookmark from the selected sequence (shown in the displayed portion of drop-down menu 1584). Clicking on the “cancel” button 1572 allows the user to get out of the bookmark functions menu 1510. Once a sequence is defined in table 1566, the digital video corresponding to that sequence may be created in memory (e.g., mass storage 370) by clicking on button 1574. This operation may necessarily require prompts from the DVD player to load one or more specified DVDs in the player until all the digital video information for all intervals defined in the sequence has been read and stored in memory. Once the digital video information for a sequence is stored in memory, the sequence of intervals (or video clips) may be played by DVD player 300 without interruption when the user clicks on the “play” button 1573. Note that the “play” button 1573 would be grayed out (i.e., non-selectable) in the preferred embodiments until the user has created the digital video sequence by clicking on button 1574. Once the digital video sequence has been created, the “play” button 1573 will be darkened and made selectable by the user.

The preferred embodiments greatly enhance a DVD user's enjoyment by allowing the user to create position bookmarks where desired on one or more DVDs, to define interval bookmarks from two position bookmarks, and to define sequences from interval bookmarks. In addition, the preferred embodiments allow the user to store digital video information for a sequence of video clips (defined by interval bookmarks) to mass storage so the sequence may be viewed seamlessly without interruption.

The embodiments and examples set forth herein were presented in order to best explain the present invention and its practical application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit and scope of the forthcoming claims. For example, in the discussion of the preferred embodiments herein, position bookmarks are used to create interval bookmarks, and interval bookmarks are used to create interval sequences. However, it is equally within the scope of the preferred embodiments to create intervals and interval sequences by directly specifying interval beginning and end points, whether or not these end points are already defined as position bookmarks and whether or not intervals are already defined as interval bookmarks.

What is claimed is:

1. An apparatus comprising:
at least one processor;
a memory coupled to the at least one processor;
a digital video disc (DVD) reader coupled to the at least one processor, the DVD reader reading digital video information stored on a DVD; and
a bookmark mechanism residing in the memory and executed by the at least one processor, the bookmark mechanism allowing a user to create at least one bookmark in the memory that corresponds to at least one position on a DVD.

2. The apparatus of claim 1 wherein the at least one bookmark comprises an interval bookmark that defines the beginning of an interval and the end of the interval on the DVD.

3. The apparatus of claim 1 wherein the at least one bookmark comprises an interval sequence that defines a plurality of intervals on the DVD.

4. The apparatus of claim 1 wherein the at least one bookmark comprises an interval sequence that defines a plurality of intervals from a plurality of DVDs.

5. The apparatus of claim 1 further comprising a mass storage coupled to the at least one processor, the mass storage storing digital video information from the DVD that corresponds to a plurality of intervals from the DVD, wherein the plurality of intervals are defined by the bookmark mechanism.

6. The apparatus of claim 1 further comprising a mass storage coupled to the at least one processor, the mass storage storing digital video information from a plurality of DVDs that corresponds to a plurality of intervals from the plurality of DVDs, wherein the plurality of intervals are defined by the bookmark mechanism.

7. The apparatus of claim 1 further comprising a user interface coupled to the at least one processor that allows a user to use the bookmark mechanism to create the at least one bookmark.

8. A method for creating at least one bookmark in a DVD memory, the method comprising the steps of:
providing a user interface that allows a user to create the at least one bookmark;
selecting a position on the DVD; and
a user using the user interface to create a position bookmark that corresponds to the selected position on the DVD.

9. The method of claim 8 further comprising the step of:
the user using the user interface to create an interval bookmark in the DVD memory by selecting a first position bookmark as the beginning of an interval and selecting a second position bookmark as the end of the interval on the DVD.

10. The method of claim 8 further comprising the step of:
the user using the user interface to create an interval sequence in the DVD memory by selecting a plurality of interval bookmarks on the DVD that each comprise two position bookmarks.

11. The method of claim 8 further comprising the step of:
the user using the user interface to store digital video information from the DVD that corresponds to a plurality of intervals from the DVD in a mass storage.

12. The method of claim 8 further comprising the step of:
the user using the user interface to store digital video information from a plurality of DVDs that corresponds to a plurality of intervals from the plurality of DVDs in a mass storage.

13. A method for creating an interval bookmark in a DVD memory, the method comprising the steps of:
providing a user interface that allows a user to create the interval bookmark;
selecting a beginning position on the DVD;
selecting an end position on the DVD;
a user using the user interface to create the interval bookmark from the selected beginning position and the selected end position.

14. The method of claim 13 wherein the selected beginning position comprises a position bookmark.

15. The method of claim 13 wherein the selected end position comprises a position bookmark.

16. A method for creating an interval sequence in a DVD memory, the method comprising the steps of:
providing a user interface that allows a user to create the interval sequence;
selecting a first interval on the DVD;
selecting subsequent intervals on the DVD;
a user using the user interface to create the interval sequence from the selected first interval and subsequent intervals.

17. The method of claim 16 wherein the first interval and each subsequent interval each comprises a beginning position and an end position on the DVD.

18. The method of claim 16 further comprising the step of:
the user using the user interface to store digital video information from the DVD that corresponds to a plurality of intervals from the DVD in a mass storage.

19. The method of claim 16 further comprising the step of:
the user using the user interface to store digital video information from a plurality of DVDs that corresponds to a plurality of intervals from the plurality of DVDs in a mass storage.

20. A method for creating a digital video sequence in a mass storage, the method comprising the steps of:
providing a user interface that allows a user to create the digital video sequence;
selecting a first interval on a first DVD;
selecting subsequent intervals from the first DVD or from other DVDs;
a user using the user interface to create the digital video sequence in the mass storage from the selected first interval and subsequent intervals.
